(19) United States
(12) Patent Application Publication
(10) Pub. No.: US 2007/0274214 A1
(43) Pub. Date: Nov. 29, 2007

(54) System and method for combining synchronous and asynchronous communications on a communications network

(76) Inventor: Oleg Logvinov, East Brunswick, NJ (US)

Correspondence Address: James Reeber, 948 US Highway 22, North Plainfield, NJ, 07060, US

(21) Appl. No.: 10/991,939

(22) Filed: Nov. 18, 2004

Related U.S. Application Data
(60) Provisional application No. 60/520,960, filed on Nov. 18, 2003.

(51) Int. Cl. H04J 1/16

(52) U.S. Cl. 370/235

(57) ABSTRACT

Management and control of the distribution of multiple, synchronous and asynchronous, simultaneously occurring audio and video data content in a communications network, as well as the bandwidth used for distributing the content on the network, is performed by all of the content source and content rendering devices operating in unison. The devices, by utilizing a method of establishing dedicated communication channels based on available bandwidth, data content, and network link reliability, can perform the distribution of content throughout the network in a manner that will reduce the latency and improve the reliability of the data distribution.

### CROSS REFERENCE TO RELATED APPLICATION

This application claims the benefit of U.S. Provisional Application No. 60/520,960 filed Nov. 18, 2003, assigned to the assignee of this application and incorporated by reference herein.

### FIELD OF THE INVENTION

The present invention relates generally to the distribution of content, such as audio, video or other data, over a local or wide area communications network, and, more particularly, to managing the distribution of content over a local or wide area communications network in a manner that will minimize the delay and improve the predictability of the delivery of the content throughout the network.

### BACKGROUND OF THE INVENTION

There exists the need to deliver multimedia content within the housing structures (residential and commercial) while minimizing the latency and improving the reliability of such delivery. It is also important to minimize the cost of the installation as well as assure that the performance of the multimedia content delivery platforms is independent from the location within the building structure. Existing powerline communication technologies satisfy the last two requirements, ease of installation and predictability of the coverage. (See HomePlug 1.0 performance report www.homeplug.org). Unfortunately, requirements related to low latency and QoS support are still unanswered by the existing implementations.

### SUMMARY OF THE INVENTION

In accordance with the present invention, communications nodes, which are coupled to one another over a communications medium to form a communications network, manage communications over the network, such as a power line network, to ensure that communications events, each of which requires the transfer of content, such as streaming content, having a predetermined bandwidth, are completed with high reliability and low latency. A node that serves as a source of a communications event establishes in the network, for the time required to complete the transfer of content associated with the communications event, at least one synchronous communications channel containing a plurality of available carriers and at least one asynchronous channel containing at least one carrier. The number of available carriers for the synchronous channel is large enough to provide for transport of the content associated with the event, such as streaming audio or video, to at least one destination node in the network with minimum latency and guaranteed quality of service (“QoS”). The source node initiates transmission of content to complete a communications event where (i) the number of currently available carriers for the medium can satisfy the bandwidth requirement for the communications event; (ii) the minimum number of carriers required to provide a minimum of latency and guarantee QoS for the bandwidth associated with the communications event does not exceed the number of currently available carriers; (iii) the number of currently available carriers does not exceed the total number of carriers of the medium less the number of carriers of the medium not suitable for communications; and (iv) the sum of the currently available carriers and the minimum number of required carriers does not exceed the total number of carriers of the medium less the number of carriers of the medium not suitable for communications.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 depicts a typical network of five communication nodes that operate using a decentralized approach to media sharing and using adhoc media access protocols to gain access to the media,

FIG. 2 depicts a scenario where Node 1 is a streaming source that is designated to deliver streaming audio to Nodes 2 and 5 and streaming video to Node 4.

FIG. 3 depicts a preferred embodiment of the system, where all nodes would start operation in adhoc mode, and then streaming channels would be established and managed later by the distributed management software residing on all network nodes.

FIG. 4 depicts the main concept of time equalization through the introduction of a “time equalizer” module that creates the same delay for all related audio and video streams, as it exists in the MAC/PHY-MAC/PHY channel.

### DETAILED DESCRIPTION OF THE INVENTION

For purposes of highlighting the features of the present invention, management of distribution of content among a plurality of devices located throughout a content distribution communications network is described in connection with content distribution over a broadband powerline network and a local area network operating based on powerline communication. It is to be understood, however, that the present invention is applicable on a network based on any medium, wired or wireless.

The proposed system in this invention is based on multi-carrier physical layer where the number of carriers exceeds a minimum number N. A minimum number N is defined as the smallest number of carriers needed to establish the communication between two or more nodes in powerline communication network, for example. The total number of available carriers is represented as M, and the number of carriers not suitable for communication is represented as K.

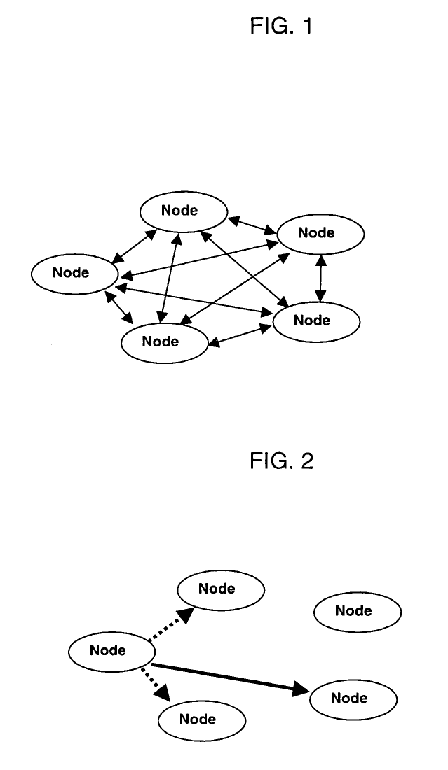

The basic idea of this invention is based on the following: During the normal operation of the system, all network nodes use a decentralized approach to media sharing and use adhoc media access protocols to gain access to the media, examples of such protocols can be found in HomePlug 1.0 (CSMA/CA) or Wireless 802.11 a/b/g. FIG. 1 depicts a typical network of five communication nodes that operate in this manner. Any node can communicate with any other node by requesting access to the media, establishing a connection, and transferring the intended data. The bandwidth available for each link between each node and each other node will likely be different, and will be determined by the communication protocol that will analyze each link and determine the availability, viability, and quality of each communication carrier, which will in turn compute the carrier numbers M and K mentioned above.

Multimedia content delivery is typically required within defined intervals of time that may span from a few minutes to several hours, for example streaming of a full-length motion picture. It is reasonable to assume that there exists the opportunity to find carriers that can offer the best performance (such as the highest SNR as an example), while delivering the broadcast data from Node 1 to Nodes 2 and 5. To exemplify this scenario, we can assume that Node 1 is a streaming source that is designated to deliver streaming audio to Nodes 2 and 5 (two rear channels of Dolby 5.1) and streaming video to the Node 4 (ASF formatted video stream). This is shown in FIG. 2.

Streaming video content typically does not benefit from protocols such as TCP, a loss of the packet has an immediate manifestation and a later retransmission of a lost packet does not create any improvements. On the other hand, packet loss can be minimized through a careful selection of the most suitable carriers and the use of Forward Error Correction (FEC).

Assuming that we have the ability to establish the number of carriers needed to satisfy bandwidth requirements for each data stream associated with multimedia content delivery, we can use the following formula to represent the bandwidth available for a specific data stream.

$$DataStreamBandwidth = {K}_{FEC} {\sum }_{i = 1 … M} {ToneMap}_{i} BitPacking$$

Assuming that the number of required carriers fits within the following constrains
N≦ΣToneMapᵢ≦M−K and ΣToneMapᵢ+N≦M−K
it would be possible to establish at least two communication channels in this system: one of the channels can be allocated for streaming media traffic, and the second channel could be allocated for adhoc communication among all of the nodes in the system.

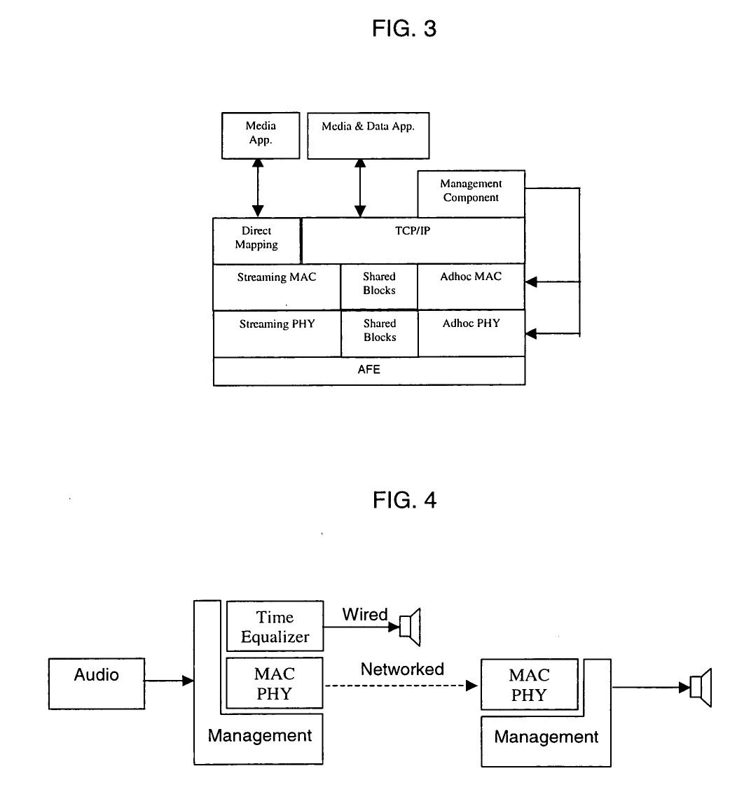

In a preferred embodiment of the system, all nodes would start operation in the adhoc mode, and then streaming channels would be established and managed later by distributed management software residing on all of the network nodes. FIG. 3 represents a possible implementation of a network node for a preferred embodiment of the system.

As is clear from FIG. 3, each node is comprised of components typically found in any networked device or adaptor, but in this case both PHY and MAC offer at least two independent channels that can be configured to be used for either asynchronous data or streaming multimedia. Carriers would be mapped, based upon the determination of a required minimum number being available from the algorithms above, to the streaming channels or the adhoc channels of the PHY and MAC. The above-mentioned PHY and MAC may also have shared components to further improve the efficiency of the implementation. As streaming and adhoc data requirements change, the carriers can be continually remapped to one or the other, as shown by the shared blocks of the MAC and PHY.

One of the key advantages of this system is the ability to create a synchronous communication channel that allows the streaming media to be transported with a minimum latency and a guaranteed QoS. This approach may also allow eliminate unnecessary data for a synchronous channel MAC and/or lower layer protocol overhead. As an example, MPEG packets can be directly transported over this channel.

Another benefit of this invention is in combining the “direct wired” and “networked” devices into a single media network. One of the challenges in such cases is in solving the time difference that would usually be created through packetization and network transport. The Synchronous channel allows us to determine the latency and, if necessary, to account for it in the system. FIG. 4 illustrates this approach.

FIG. 4 depicts the main concept of time equalization through the introduction of a “time equalizer” module that creates the same delay for all related audio and video streams, as it exists in the MAC/PHY-to-MAC/PHY channel. In this manner, a “direct wired” and a “networked” device could both be utilized to each provide a synchronized channel to and end component, such as a speaker, to facilitate a synchronized system, such as a surround sound application.

Although preferred embodiments of the present invention have been described and illustrated, it will be apparent to those skilled in the art that various modifications may be made without departing from the principles of the invention.

What is claimed is:

1. A multi-carrier communications system including a plurality of communications nodes coupled to one another over a communications medium, wherein the medium includes a predetermined number of data carriers and each of the nodes includes a communications event management module,
wherein the management module, for a communication event requiring use of a minimum number of carriers to satisfy a bandwidth requirement corresponding to the event, determines whether:
(i) currently available carriers from the predetermined number of carriers for the medium can satisfy the communications event bandwidth requirement,
(ii) the minimum number of carriers does not exceed the currently available carriers,
(iii) the number of currently available carriers does not exceed the predetermined number of carriers of the medium less the number of carriers of the medium not suitable for communications, and
(iv) the sum of the currently available carriers and the predetermined number of event carriers does not exceed the predetermined number of carriers of the medium less the carriers of the medium not suitable for communications, and
wherein, if each of the conditions (i), (ii), (iii) and (iv) is satisfied, the management module defines at least two communications channels for the system while the communications event is occurring, wherein the first channel includes a plurality of first carriers for completing the communications event as a synchronous communication and the second channel includes at least a second carrier for completing an asynchronous communication.

2. The system of claim 1, wherein the communications event includes at least one of a time synchronized fixed bandwidth event and a demand driven variable bandwidth communications event.

3. The system of claim 1, wherein the communications medium is a conventional power line network.

4. The system of 1, wherein the currently available carriers are selected from the carriers for the medium based on information obtained from channel training of the medium and analysis of carriers transmitted on the medium on a per-carrier basis.

5. The system of 1, wherein the currently available carriers are selected from at least one of historical channel data, real time channel data, known and learned patterns of changes of channel related parameters and anticipated channel behavior.

6. The system of 1, wherein the currently available carriers are selected based on information obtained from analysis of adhoc communications occurring on the medium.

7. The system of claim 1, wherein the communications event includes streaming multimedia content.

8. The system of claim 7, wherein the streaming content is directly mapped onto the first channel.

9. The system of claim 8, wherein the streaming content is MPEG over PHY frame.

10. The system of claim 1, wherein the carriers of the available carriers selected for the first channel are selected based on information obtained from tone mapping of the medium.

11. The system of claim 1, wherein the second channel is for communicating using conventional TCP/IP protocol.

12. The system of claim 1, wherein the currently available carriers are selected based on information obtained from forward error correction analysis of carriers of the medium.

13. The system of claim 1, wherein the communications event includes streaming data for playback at a plurality of destination nodes in the system, wherein the management module of a first source node of the system includes an equalization module, wherein the equalization module delays transmission of at least one carrier on the first channel to at least a first of the plurality of the destination nodes such that playback of the streaming data at the destination nodes is synchronized.

14. A method for multi-carrier communications in a communications system, wherein the system includes a plurality of communications nodes coupled to one another over a communications medium, wherein the medium includes a predetermined number of data carriers and each of the nodes includes a communications event management module, the method comprising:
determining a minimum number of carriers required to satisfy a bandwidth requirement corresponding to the communications event,
completing the communications event if:
(i) currently available carriers from the predetermined number of carriers for the medium can satisfy the communication event bandwidth requirement,
(ii) the predetermined number of event carriers does not exceed the currently available carriers,
(iii) the number of currently available carriers does not exceed the number of carriers of the medium less the number of carriers of the medium not suitable for communications, and
(iv) the sum of the currently available carriers and the predetermined number of event carriers does not exceed the number of carriers of the medium less the number of carriers of the medium not suitable for communications, and
wherein the completing the event includes establishing a first channel having a plurality of first carriers for completing the communications event as a synchronous communication and a second channel having at least a second carrier for completing an asynchronous communication.
